(19) United States
(12) Patent Application Publication
(10) Pub. No.: US 2013/0057229 A1
(43) Pub. Date: Mar. 7, 2013

(54) POWER FACTOR CORRECTION APPARATUS AND METHOD

(71) Applicants: Manjing XIE, Fremont, CA (US); Zhixiang LIANG, San Ramon, CA (US)

(72) Inventors: Manjing XIE, Fremont, CA (US); Zhixiang LIANG, San Ramon, CA (US)

(73) Assignee: INTERSIL AMERICAS INC., Milpitas, CA (US)

(21) Appl. No.: 13/316,448

(22) Filed: Dec. 9, 2011

Related U.S. Application Data
(60) Provisional application No. 61/530,886, filed on Sep. 2, 2011.

(51) Int. Cl. G05F 1/70

(52) U.S. Cl. 323/209

(57) ABSTRACT

The various embodiments may include a power supply having a first loop in communication with a power stage of the power supply. A second loop in communication with the first loop may generate a negative reactance value that increases a power factor for the power supply to approximately one. A power supply may also include a rectifier coupleable to an input supply. A power factor compensation circuit coupled to the rectifier may generate a negative reactance. The negative reactance may reduce a phase angle between a current and a voltage provided to the input supply. A method may include sensing an output of a power supply, and adjusting the sensed value. The adjusted value may be compared to a reference value to generate an error value. The error value and a negative reactance value may be combined and the result may be provided to the power supply.

### CLAIM OF PRIORITY

The present application claims the benefit of copending U.S. Provisional Patent Application Ser. No. 61/530,886 filed on Sep. 2, 2011; which application is incorporated herein by reference in its entirety.

### TECHNICAL FIELD

Electromagnetic interference (EMI) filters and power factor correction (PFC) devices are disclosed. More particularly, EMI reduction filters for PFC devices in switching power converters are disclosed.

### BACKGROUND

The rapid development of power electronics technology has relied, at least in part, on the steadily decreasing size of switching power converters. Unfortunately, the physical size of input filters in higher power factor conversion (PFC) devices has not achieved size reductions in proportion to other portions of the converter assembly. Accordingly, input filters used in PFC devices may account for a large proportion of the weight and physical size in the converter assembly.

### SUMMARY

Electromagnetic interference (EMI) filters and power factor correction (PFC) devices in switching power converters are disclosed. In an aspect, a power supply may include a first loop in communication with a power stage of the power supply. The power supply may also include a second loop in communication with the first loop that may be configured to generate a negative reactance value that increases a power factor for the power supply to approximately one. In another aspect, a power supply may include a rectifier coupleable to an input supply. The power supply may also include a power factor compensation circuit coupled to the rectifier that may be configured to generate a negative reactance. The negative reactance may be operable to reduce a phase angle between a current and a voltage provided to the input supply. In still another aspect, a method of power factor correction in a power supply may include sensing an output of the power supply, and adjusting the sensed value. The adjusted value may be compared to a reference value to generate an error value. The error value and a negative reactance value may be combined and the result may be provided to the power supply.

### BRIEF DESCRIPTION OF THE DRAWINGS

FIG. 1 is a functional block diagram of an input stage of a switching power supply.

FIG. 2 is a phasor diagram that further describes the voltage and current relationships of the input stage of FIG. 1.

FIG. 3 is a functional block diagram of an input stage that may form a part of a switching power supply, according to the various embodiments.

FIG. 4 is a schematic view of an input filter, according to the various embodiments.

FIG. 5 is a phasor diagram that further describes the voltage and current relationships of the input stage of FIG. 3, according to the various embodiments.

FIG. 6 is a partial schematic view of an input stage that may form a part of a switching power supply, according to the various embodiments.

FIG. 7 is a functional block diagram of a switching power supply, according to the various embodiments.

FIG. 8 is a functional block diagram of a control loop of the switching power supply of FIG. 7, according to the various embodiments.

FIG. 9 is a flowchart that describes a method of adjusting a power factor in a power supply, according to the various embodiments.

### DETAILED DESCRIPTION

In the following description, certain details are set forth in connection with the various embodiments to provide a sufficient understanding. It will be appreciated that the various embodiments may be practiced without these particular details. Furthermore, it will be appreciated that the various embodiments described below do not limit the scope, and that various modifications, equivalents, and combinations of the various embodiments and components of the various embodiments are within the scope presently contemplated. Embodiments that may include fewer than all the disclosed components of any of the various embodiments may also be within the scope although not expressly described in detail. Although the operation of certain well-known components and/or well-known processes may not be shown or described in detail, such omissions may be made to avoid unnecessarily obscuring the various embodiments as they are described.

As a preliminary matter, the reduction of unintentional electromagnetic emissions from electronic devices has received significant regulatory attention in recent years. For example, switching power converters, as well as many other electronic devices, may generate significant amounts of unintentional electromagnetic emissions which may be subject to regulation in the U.S. under the authority granted by Chapter 47 of the Code of Federal Regulations (CFR), Part 15 (Subpart B), and/or alternatively, under MIL-STD 461C. Outside the U.S., similar regulatory restrictions with respect to unintentional electromagnetic emissions from electronic devices using discrete frequencies or repetition rates may be applicable, such as VDE (Verband Deutscher Electrotechniker) 0871, for example. In the accordance with the foregoing standards, relatively low electromagnetic interference (EMI) levels are generally mandated to substantially attenuate switching power noise. The input filter design should be configured to achieve relatively low EMI levels and maintain a relatively small size, while achieving a power factor that is approximately unity.

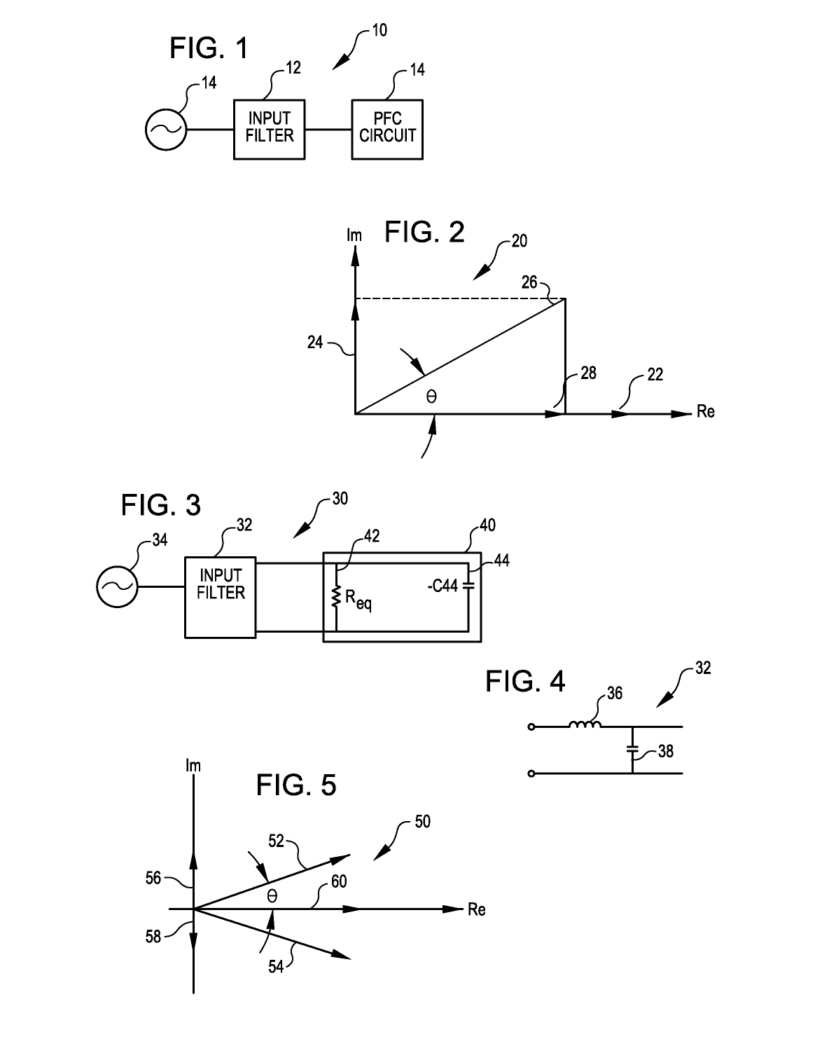

FIG. 1 is a functional block diagram of an input stage 10 that may form a part of a switching power supply. The input stage 10 may include an input filter 12 that may be configured to be coupled to an input supply 14. The input filter 12 may include any suitable operational arrangement of elements that may be suitably arranged in various filter designs. For example, the input filter 12 may include any suitable arrangement of resistors, capacitors, inductors, and transformers that may be configured to form a passive filter, such as a Chebyshev filter design, although other suitable filter configurations may also be used. For example, other passive filter designs may include nonlinear elements, or more complex linear elements, such as transmission lines. The input filter 12 may be coupled to a power factor compensation (PFC) circuit 14 that may be configured to provide a relatively low phasor angle between an input voltage (e.g., from the input supply 14) and a current applied to the input stage 10. Accordingly, the PFC circuit 14 may provide a phasor angle that is approximately equal to zero, and a power factor approximately equal to one.

With reference now to FIG. 2, a phasor diagram 20 is shown, which may be used to further describe the voltage and current relationships of the input stage 10 of FIG. 1. Briefly, the phasor diagram 20 may be used to graphically illustrate the effects of various reactive components, such as inductive and capacitive devices, which may introduce phase differences between the voltage and current applied to the input stage 10. A line input voltage 22 (e.g., from the input supply 14 of FIG. 1) may graphically extend along a real axis (Re) in a complex plane. Correspondingly, a reactive component 24 may graphically extend along an imaginary axis in the complex plane. The reactive component 24 may represent the effects of capacitive and inductive effects in the input filter 12 (as shown in FIG. 1). Although the reactive component 24 is shown in FIG. 2 as extending along a positive direction on the imaginary axis, it is understood that the reactive component 24 may also extend along a negative direction on the imaginary axis, depending upon the reactive behavior of the input filter 12. Accordingly, a line input current 26 may be displaced from the real axis (Re) by a phasor angle θ. A voltage input 28 to the PFC circuit 14 (as shown in FIG. 1) may be reduced. An effective PFC circuit 14 may therefore reduce a magnitude of the phasor angle θ so that the power transferred to the input stage 10 (of FIG. 1) may be increased.

FIG. 3 is a functional block diagram of an input stage 30 that may form a part of a switching power supply, according to the various embodiments. The input stage 30 may include an input filter 32 that may be configured to be coupled to an input supply 34. With reference briefly now also to FIG. 4, the input filter 32 may include an inductor 36 and a capacitor 38 configured in an “L” filter configuration, although other filter configurations may also be used, which may include additional inductive and capacitive components, or even other passive circuit elements. The input filter 32 may be coupled to a PFC circuit 40. In general, an input impedance of the PFC circuit 40 may be resolved into an equivalent resistance (R_{eq}) 42. The equivalent resistance (R_{eq}) 42 may not be sufficient to present a resistive input impedance to the PFC circuit 40 due to the presence of reactive elements in the input filter 32 (e.g., the inductor 36 and the capacitor 38 as shown in FIG. 4). In accordance with the various embodiments, the PFC circuit 40 may be configured to include a negative capacitance (−C) 44 that is electrically in parallel with the equivalent resistance (R_{eq}) 42.

With reference now also to FIG. 5, a phasor diagram 50 is shown, which may be used to further describe the voltage and current relationships of the input stage 30 of FIG. 30. As shown therein, a current component 52 corresponding to a current magnitude through the input filter 32 (as shown in FIG. 3) may be graphically offset from the real (Re) axis by a phasor angle θ due to a reactive component 56. A current component 54 into the PFC circuit 40 may also be graphically offset from the real (Re) axis, and may “lag” the current component 52. The introduction of a reactive component 58 by the negative capacitance (−C) 44 (as shown in FIG. 3) may at least partially cancel the reactive component 56 since the reactive component 58 extends oppositely along the imaginary axis of the phasor diagram 50. Accordingly, the resulting input current component 60 may extend substantially along the real axis (Re) of the phasor diagram 50, so that the phasor angle 8 may be reduced in magnitude, and the power factor may approach one.

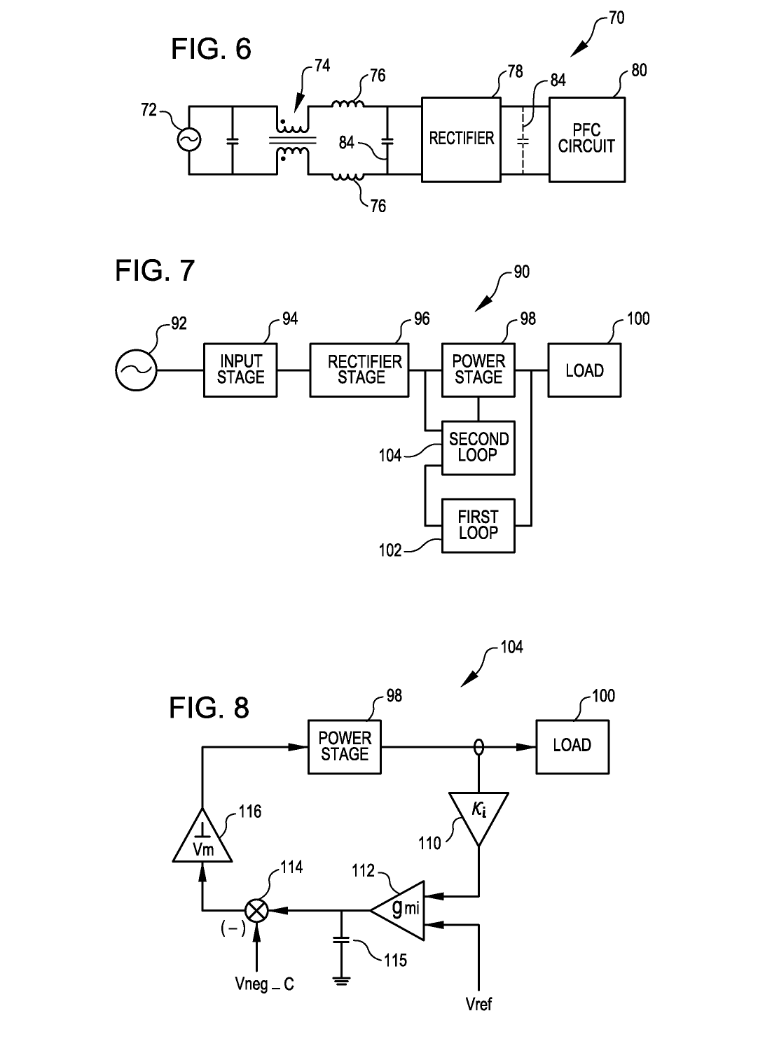

FIG. 6 is a partial schematic view of an input stage 70 that may form a part of a switching power supply, according to the various embodiments. The input stage 70 may be configured to be coupled to an input supply 72, which may include a conventional alternating current (AC) supply source, such as a conventional AC electrical main having a predetermined root-mean-square (RMS) voltage and a predetermined line frequency. The input supply 72 may be coupled to a common-mode transformer 74 having a predetermined turns ratio. Briefly, the common-mode transformer 74 may be configured to reduce common-mode noise that may exist on the relatively long electrical conductors associated with the AC electrical main. The input stage 70 may also include a pair of inductors 76 that may be configured to reduce differential-mode noise that may be associated with the AC electrical main. The input stage 70 may also include a rectifier 78 that may be coupled to the input supply 72, which may be configured to rectify the AC voltage received from the input supply 72, and to convert the AC voltage to a pulsating waveform having a relatively steady DC value. Accordingly, the rectifier 78 may include a half-wave rectification apparatus, or it may include a full-wave rectification apparatus.

The input stage 70 may include a PFC circuit 80 that may be configured to generate a negative capacitance, such as the negative capacitance (−C) 44, which was described above. Additional details regarding the generation of the negative capacitance (−C) will be described in further detail below. The input stage 70 may also include a first safety capacitor 82 coupled to the input stage 70 in a first position and a second safety capacitor 84 coupled to the input stage 70 in a second position. The first safety capacitor 82 and the second safety capacitor 84 may be configured as “X-type” safety capacitors to suppress electrical noise and protect the input stage 70 against catastrophic damage that may occur due to electrical surges. The first safety capacitor 82 and the second safety capacitor 84 may also prevent the input stage 70 from receiving undesired electromagnetic and radio frequency interference. Since the first safety capacitor 82 and the second safety capacitor 84 may be coupled between line phases (e.g., across the line, as shown in FIG. 6), the first safety capacitor 82 and the second safety capacitor 84 may effectively reduce symmetrical interference that may occur. Although FIG. 6 shows the first safety capacitor 82 and the second safety capacitor 84 coupled across the line as X-type safety capacitors, it is understood that Y-type safety capacitors that may be coupled between a line phase and a point of zero potential may be present, and may thus be considered within the scope of the present embodiments.

Still referring to FIG. 6, the first safety capacitor 82 and the second safety capacitor 84 may be coupled in various locations within the input stage 70. For example, the second safety capacitor 84 may alternatively be coupled to the input stage 70 in a third position (as shown by the broken line representation of the second safety capacitor 84 shown in FIG. 6). The inventors have made the discovery that the movement of the second safety capacitor 84 from the second position to the third position (e.g., from a position before the rectifier 78, to a position following the rectifier 78) may be made feasible by the generation of the negative capacitance (−C) 44 (as shown in FIG. 3) in the PFC circuit 80. Various advantages may accrue from positioning the second safety capacitor 84 from the second position to the third position. For example, at least one of the first safety capacitor 82 and the second safety capacitor 84 may be more compact, thus significantly reducing the physical size of the input stage 70, and by extension, the size of a switching power supply that incorporates the input stage 70. Furthermore, the inventors have made the discovery that positioning the first safety capacitor 82 in the first position and the second safety capacitor 84 in the second position may allow power factor deterioration to occur under conditions of high input line voltage and light loading conditions on the switching power supply that incorporates the input stage 70. Accordingly, positioning the second safety capacitor 84 in the third position, together with generating a negative capacitance within the PFC circuit 80 may permit significant improvements in switching power supply operation.

FIG. 7 is a functional block diagram of a switching power supply 90, according to the various embodiments. The switching power supply 90 may be configured to be coupled to an input supply 92, which may include a conventional AC supply source, such as a conventional AC electrical main supply, as described earlier. The switching power supply 90 may also include a rectifier stage 94 that may be configured to convert a symmetrical AC waveform received from the input supply 92 to a pulsating waveform having a DC component. Accordingly, the rectifier stage 94 may include a half-wave rectification device, or a full-wave rectification device. In either case, the rectifier stage 94 may be coupled to a power stage 96 that may be configured to switch and condition the rectified waveform received from the rectifier stage 96, in addition to performing other operations, such as boosting. The power stage 98 may also be coupled to an electrical load 100.

The switching power supply 90 may include a first loop 102 and a second loop 104. The first loop 102 may be a voltage control loop that may be configured to compare an output voltage to a reference value, and to generate an error signal based upon a difference between the output voltage and the reference value. The first loop 102 may have a relatively narrow bandwidth, which may be approximately about ten hertz (Hz), although other suitable bandwidth values may be used. The second loop 104 may be a current control loop that has a bandwidth that may be somewhat larger than the first loop 102. For example, and in accordance with the various embodiments, the second loop 104 may have a bandwidth that may be approximately one-tenth of a switching speed of a transistor in the power stage 98. Accordingly, the bandwidth may range between approximately two kilohertz (kHz) and approximately 150 kHz, although other bandwidth values may also be suitable. One operational function of the second loop 104 may be to maintain approximately balanced current pulses through an inductive element in the switching power supply 90.

The second loop 104 may be configured to generate the negative capacitance described in connection FIG. 3. Briefly, the negative capacitance may provide appropriate power factor compensation so that the current drawn from the input supply 34 (as shown in FIG. 3) may be substantially in phase with the voltage provided by the input supply 34.

Referring now to FIG. 8, a functional block diagram of the second control loop 104 in accordance with the various embodiments will now be discussed. With continued reference also to FIG. 7, the second loop 104 may include a current sense gain stage 110 that is operable to sense a current communicated to the load 100, and to apply a gain Kᵢ to the sensed current. An output of the current sense gain stage 110 may be communicated to a current compensation stage 112 that may be configured to compare the output of the current sense gain stage 110 to a reference voltage V_{ref}. In accordance with the various embodiments, the reference voltage V_{ref} may be proportional to a rectified voltage (e.g., an output of the rectifier stage 96 of FIG. 7), and gₘᵢ may be a gain value for the current sense gain stage 110. An output from the current compensation stage 112 may be communicated to a capacitor 115 and to a negative capacitance generation stage 114, where the output may be combined with V_{neg}_{_{—}}_{c}, which may also be proportional to the rectified voltage (e.g., an output of the rectifier stage 96 of FIG. 7). Accordingly, V_{neg}_{_{—}}_{c} may be expressed as k_{ff}_{_{—}}_{c} multiplied by the rectified voltage, where k_{ff}_{_{—}}_{c} may be a scaling factor. The negative capacitance generation stage 114 may communicate an output to pulse-width modulation stage 116 that may be operable to apply a scaling factor (1/Vₘ) to the output to pulse-width modulation stage 116, where Vₘ may include an amplitude of a switched output of the power stage 98. The negative capacitance (−C) may be determined based upon the following expression:

C_{eq}˜[(Vₘ/V₀)−k_{ff}_{_{—}}_{c}]C_{f}/Kᵢgₘᵢ

where C_{F} is the capacitance of the capacitor 115. Accordingly, the capacitance value C_{eq} will assume negative values when the quantity [(Vₘ/V₀)−k_{ff}_{_{—}}_{c}]<1, or (equivalently) when k_{ff}_{_{—}}_{c}>(Vₘ/V₀).

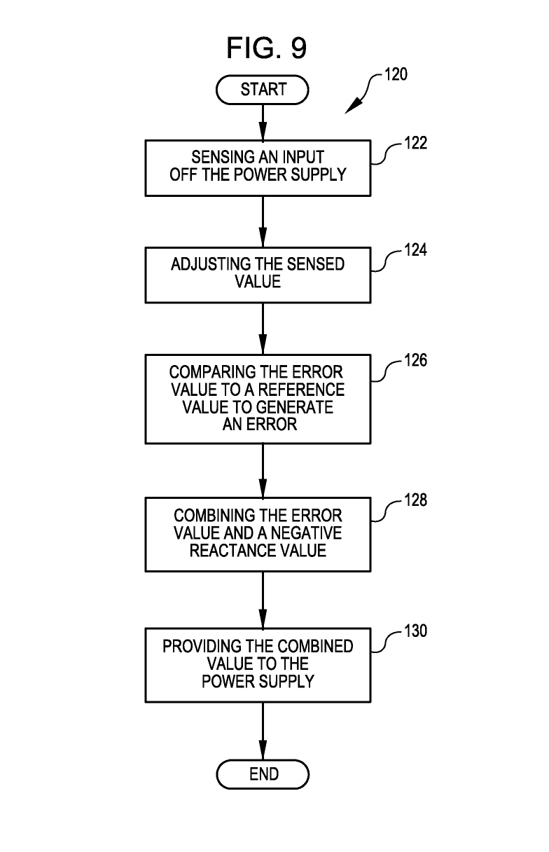

FIG. 9 is a flowchart that will be used to describe a method 120 of adjusting a power factor in a power supply. At 122, an output of the power supply may be sensed. At 124, the sensed value may be adjusted. At 126, the adjusted value from 124 may be compared to a reference value to determine an error based upon a difference between the adjusted value and the reference value. At 128, the error value may be combined with a negative capacitance value. In accordance with the various embodiments, the negative capacitance value may be proportional to a difference between a voltage ratio and a scaling factor, where the difference includes a negative value. At 130, the combined value may be provided to the power supply so that a negative capacitance may be generated that offsets reactive effects in the power supply.

It is understood that even though various embodiments and numerous details of the various embodiments have been set forth in the foregoing disclosure, it is to be regarded as illustrative only, and various changes may be made, and yet remain within the broad principles of the various embodiments. For example, certain of the components described above may be implemented using either digital or analog circuitry, or a combination of both, and also, where appropriate, may be realized in part, or even wholly through software configured to be executed on suitable processing devices. It should also be noted that various functions performed by the components in the various embodiments may be combined to be embodied in fewer elements or separated and performed by more elements. Therefore, the various embodiments may be limited only by the appended claims. Moreover, although embodiments of sigma-delta analog-to-digital converters have been disclosed, various attributes associated with the various embodiments may be applicable to digital-to-analog sigma-delta converters as well and to the extent such principles are applicable to such digital-to-analog converters these converters are within the scope of the various embodiments.

What is claimed is:

1. A power supply, comprising:
a first loop in communication with a power stage of the power supply; and
a second loop in communication with the first loop and configured to generate a negative reactance value that increases a power factor for the power supply to approximately one.

2. The power supply of claim 1, wherein the negative reactance value includes a negative capacitance value.

3. The power supply of claim 1, wherein the second loop comprises a first stage configured to receive an output value for the power supply and to adjust the received output value, and a second stage coupled to the first stage configured to compare the output value from the first stage to a reference value, and to generate a error value based upon a difference between the output value from the first stage to a reference value.

4. The power supply of claim 3, comprising a third stage configured to receive the error value, and to combine the error value with the negative reactance value.

5. The power supply of claim 4, wherein the negative reactance value is proportional to a difference between a scaling factor and a voltage ratio.

6. The power supply of claim 1, comprising a rectifier stage and a load coupled to the power stage.

7. A power supply, comprising:
a rectifier coupleable to an input supply; and
a power factor compensation circuit coupled to the rectifier and configured to generate a negative reactance that is operable to reduce a phase angle between a current and a voltage provided to the input supply.

8. The power supply of claim 7, comprising at least one safety capacitor coupled to an output of the rectifier and an input of the power factor compensation circuit.

9. The power supply of claim 8, wherein the at least one safety capacitor comprises one of an X-type safety capacitor and a Y-type safety capacitor.

10. The power supply of claim 8, comprising at least one safety capacitor coupled to an input of the rectifier.

11. The power supply of claim 10, wherein the at least one safety capacitor comprises one of an X-type safety capacitor and a Y-type safety capacitor.

12. The power supply of claim 7, comprising at least one of a common mode transformer, and a differential mode filter.

13. The power supply of claim 7, wherein the negative reactance includes a negative capacitance.

14. A method of power factor correction in a power supply, comprising:
sensing an output of the power supply;
adjusting the sensed value;
comparing the adjusted value to a reference value to generate an error value; and
combining the error value and a negative reactance value and providing the result to the power supply.

15. The method of claim 14, wherein sensing an output comprises sensing the output proximate to an electrical load.

16. The method of claim 14, wherein adjusting the sensed value comprises applying a gain factor to the sensed value.

17. The method of claim 14, wherein comparing the adjusted value to a reference value includes comparing the adjusted value to a reference value that is proportional to a rectified voltage value of a rectification stage of the power supply.

18. The method of claim 14, wherein combining the error value and a negative reactance value comprises combining the error value with a negative capacitance value.

19. The method of claim 18, wherein combining the error value with a negative capacitance value comprises maintaining a difference of a voltage ratio and a scaling factor to be less than one, and combining the difference with the error value.

20. The method of claim 14, wherein providing the result to the power supply comprises normalizing the result by an amplitude of a switched power value.
